(19) United States
(12) Patent Application Publication
(10) Pub. No.: US 2006/0252557 A1
(43) Pub. Date: Nov. 9, 2006

(54) Axial retaining arrangement for a bearing bushing in a universal joint

(75) Inventors: Hans-Jurgen Schultze, Bottrop (DE); Erhard Muller, Hartingen (DE); Andreas Neises, Borgisch Gladback (DE); Lars Christoph Schafer, Hartingen (DE)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: Spicer Gelenkwellenbau GmbH

(21) Appl. No.: 11/414,859

(22) Filed: May 1, 2006

(30) Foreign Application Priority Data
May 4, 2005 (DE) 102005021376.6

(51) Int. Cl. F16D 3/16

(52) U.S. Cl. 464/130

(57) ABSTRACT

An axial retaining arrangement for a bearing bushing in a bearing bore, forming a bore wall, of a yoke arm of a joint yoke belonging to a universal joint or of a bearing element by means of a retaining ring, wherein the bearing bushing has an outer face, with which it rests in the bearing bore, the bearing bore forms a longitudinal axis, the bore wall of the bearing bore or the outer face of the bearing bushing have an annular groove centered on the longitudinal axis, the retaining ring has a first ring portion, retained in the annular groove, has at least one second ring portion following to the first ring portion, which is elastic in the radial direction and which at least forms one engagement edge, which, depending on the arrangement of the annular groove to the bearing bore or the bearing bushing is pressing against the bore wall or the outer face.

### BACKGROUND OF THE INVENTION

This invention relates to an axial retaining arrangement for a bearing bushing in a through-extending bearing bore, forming a bore wall, of a yoke arm of a joint yoke, belonging to a universal joint, or of a bearing element by means of a retaining ring.

Such an axial retaining arrangement is, for example, described in U.S. 2005/0037850 A1. In this case, a bearing bushing is provided that has an outer face with which it is accommodated in the bearing bore of the yoke arm of a universal joint. The bearing bore forms a longitudinal axis, along which the bearing bushing is inserted from the radial outer side of the yoke arm into the bearing bore. An annular groove is provided in the bearing bushing with a distance to the radial outer side of the yoke arm, into which a retaining ring is inserted and which is supported on the bottom of the bearing bushing. The retaining ring is formed solid and has an outer diameter, which is stepped in a stair-like manner, when seen in a cross-section, and which is used to balance out tolerances, to align the two bearing bushings arranged on one axis (on the axis of rotation of the joint yoke), and furthermore to be able to adjust the necessary clearances. Such a construction has the advantage that in relation to known assembly types, in which differently thick retaining rings are used, only the use of one or few types of retaining ring types is necessary. It necessitates, however, at the same time, correspondingly deep annular grooves in the bearing bore. A large offset of the annular groove from the radially outer side of the yoke arm is necessary so that at a predetermined torque capacity of such a universal joint, large rotational diameters become necessary, as the bearing bushing has to be supported, depending on the torque capacity, over a specific length along the longitudinal axis of the bearing bore.

### SUMMARY OF THE INVENTION

This invention is based on the object to propose an axial retaining arrangement for a bearing bushing in a universal joint in which the assembly is simplified and in which furthermore, with predetermined dimensions, i.e., predetermined rotational diameter, an increase of the bearing life span or, with the same torque transmissibility, a smaller insertion space, i.e. rotational diameter, is achievable.

This object is solved according to the invention by an axial retaining arrangement for a bearing bushing in a bearing bore, forming a bore wall, of a yoke arm of a joint yoke belonging to a universal joint or of a bearing element by means of a retaining ring. The bearing bushing has an outer face with which it rests in the bearing bore. The bearing bore forms a longitudinal axis, and the bore wall of the bearing bore or the outer face of the bearing bushing has an annular groove centered on the longitudinal axis. The retaining ring has a first ring portion that is retained in the annular groove, has at least one second ring portion following to the first ring portion, which is elastic in the radial direction, and which at least forms one engagement edge that, depending on the arrangement of the annular groove to the bearing bore or the bearing bushing, is pressing against the bore wall or the outer face.

The advantage of this arrangement is that a retaining ring is omitted, which is arranged following the bearing bushing axially along the longitudinal axis of the bearing bore. Therefore, for the assembly and the support of the bearing bushing, the whole length of the bearing bore along the longitudinal axis can be used. This leads to an increase of the transmittable torque in the use of a universal joint or to an increase of the life span, respectively. A further advantage is that instead of a multitude of retaining rings or repeated assembly, only one type of retaining ring is necessary. The centrifugal forces produced during the rotation of the universal joint lead to the fact that the support is further improved as the engagement edge cuts deeper into the outer face of the bearing bushing or, in the assembly arrangement of the retaining ring to the bearing bushing, into the bore wall of the bearing bore. The engagement in the bore wall or in the outer face of the bearing bushing also produces the further advantage that a rotation of the bearing bushing, due to the reciprocating rotational movement of the bearing journal of the journal cross around the longitudinal axis of the bearing bore, and, thus, fretting corrosion is prevented.

As a whole, an advantage is also achieved in the assembly as, only by means of pushing-in of the bearing bushing, a centered assembly is possible, which leads to smaller unbalanced masses so that after the assembly, fewer balancing runs and fewer balancing weights are necessary. This leads altogether to a reduction of the costs.

In an embodiment of the invention it is provided that a portion of the bore wall or the outer face forms a contact portion for the engagement edge of the retaining ring, wherein the contact portion has a rough surface or is provided with a knurl or with circumferential grooves.

Thus, it is possible, to increase the engagement of the engagement edge(s) in the counter surface, i.e., the bore wall of the bearing bore or the outer face of the bearing bushing, so that a secure retainment along the longitudinal axis is achieved. In this case, the contact portion can be designed preferably such that it does not project over the residual portion of the outer face of the bearing bushing or of the bore wall so that the corresponding counter face is not damaged when the bearing bushing is inserted into the bearing bore. A further advantage of the arrangement is also that the annular groove can be arranged practically at any position along the longitudinal axis of the bearing bore in the bearing bore itself or otherwise in the outer face of the bearing bushing.

An advantageous embodiment provides that the at least one second ring portion having the engagement edge extends relative to the bore wall in the assembled condition with an angle (A), which is larger than 70 and smaller than 90°.

Hereby, it is ensured that during the influence of forces onto the bearing bushing against the insertion direction a secure and deeper gripping of the engagement edge into the corresponding counter face, i.e., the bore wall or the outer face of the bearing bushing, is produced.

The invention provides two embodiments concerning the arrangement of the annular groove for the accommodation of the retaining ring. In a first embodiment, it is provided that if the annular groove is arranged in the bore wall of the bearing bore, the engagement edge of the retaining ring is facing away from an insertion end of the bearing bore, through which the bearing bushing is inserted into the bearing bore.

In a second embodiment, it is provided that if the annular groove is arranged in the bore wall of the bearing bore, the engagement edge of the retaining ring is facing an insertion end of the bearing bore, through which the bearing bushing is inserted into the bearing bore.

For facilitating the assembly of the retaining ring in the annular groove, accommodating the same, it is provided that the retaining ring is separated in the direction of the longitudinal axis at one position. It is advantageous when the retaining ring is formed from a metal sheet, wherein the at least one second ring portion is bent relative to the first ring portion, if seen in a longitudinal section, forming a V. The retaining ring can be formed such that the first ring portion is formed solid, to which the at least one second ring portion, which has the engagement edge, is unitarily connected.

The engagement edge can be formed sharp so that forces acting against the insertion direction of the bearing bushing into the bearing bore lead to a cutting-into the counter surface, which further improves the retainment.

The object on which the invention is based is solved also by an axial retaining arrangement for a bearing bushing with a continuously through extending bearing bore, forming a bore wall, of a yoke arm of a joint yoke belonging to a universal joint or of a bearing element, wherein the bearing bushing has an outer face, with which it rests in the bearing bore. The bearing bore forms a longitudinal axis. The bearing bore forms an insertion end for the bearing bushing. The bore wall of the bearing bore is provided in the direction towards the insertion end over a circumference with first teeth offset axially along the longitudinal axis, which tips do not project in direction towards the longitudinal axis over the residual face of the bore wall. The bearing bushing has, at a rearward end when viewed in an insertion direction into the bearing bore, second teeth on the outer face interacting with the first teeth, which second teeth engage in the first teeth and project correspondingly over the outer face of the bearing bushing away from the longitudinal axis.

Preferably, the teeth are formed like sawteeth. The steep flanks serve for the support.

Preferred embodiments of the invention are schematically shown in the drawings.

### BRIEF DESCRIPTION OF THE DRAWINGS

FIG. 1 is a side elevational view, partially in cross section, of a universal joint shaft with two universal joints.

FIG. 2 is an enlarged sectional elevational view of a portion of FIG. 1 indicated by a circle Z and showing a first embodiment of a retaining ring in accordance with this invention.

FIG. 3 is an enlarged sectional elevational view of a portion of FIG. 1 showing a second embodiment of a retaining ring in accordance with this invention.

FIG. 4 is a further enlarged sectional elevational view of the yoke arm and the retaining ring illustrated in FIG. 2.

FIG. 5 is a further enlarged sectional elevational view of the retaining ring illustrated in FIG. 2, wherein, however, the contact portion at the outer face of the bearing bushing is provided with grooves.

FIG. 6 is an enlarged sectional elevation view of a third embodiment of a retaining ring in accordance with this invention.

FIG. 7 is an enlarged sectional elevation view of a fourth embodiment of a retaining ring in accordance with this invention.

### DETAILED DESCRIPTION OF THE PREFERRED EMBODIMENTS

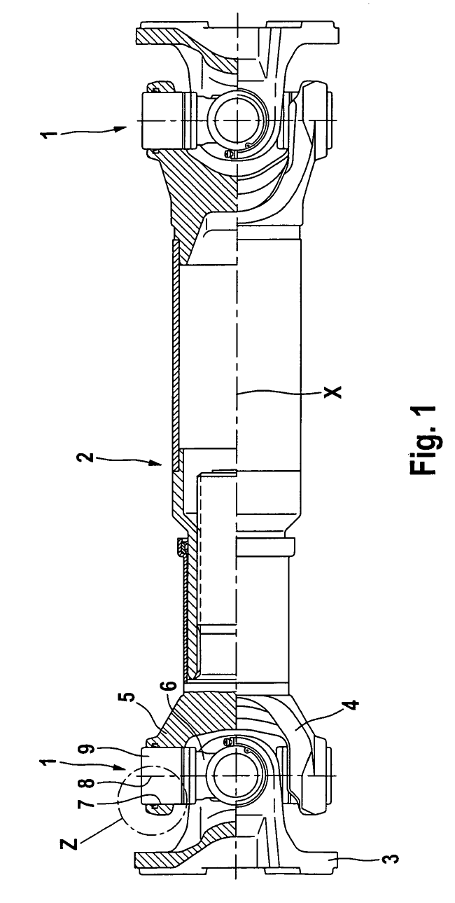

Referring now to the drawings, there is illustrated in FIG. 1 a universal joint shaft that includes two universal joints, each indicated generally at 1, at the ends thereof and a length compensation portion, indicated generally at 2, arranged therebetween. The two universal joints 1 can be formed essentially the same, although such is not required, and only the connections to the length compensation portion 2 are formed differently. All of the components are shown aligned on an axis of rotation X. The universal joint 1, shown on the left in FIG. 1, is described in more detail below.

The universal joint 1 includes a first joint yoke 3 that is provided with a flange and serves for connecting a driving or to be driven component thereto. The universal joint 1 also includes a second joint yoke 4 that has a journal, which forms a component of the length compensation portion 2.

The two joint yokes 3, 4 each have, respectively, two yoke arms 5 that have respective bearing bores 7. The bearing bores 7 of the two yoke arms 5 of the second joint yoke 4 are centered on a common longitudinal axis 8. The yoke arms of the two joint yokes 3, 4 are arranged offset by 90° to each other around the axis X.

The two joint yokes 3, 4 are connected to each other by a journal cross unit 6 that includes a journal cross having four journals that are arranged at a right angle to each other and on which, respectively, a bearing bushing 9 is arranged, i.e., by means of interpositioning of rolling members and a seal. Each bearing bushing 9 is accommodated in an associated bearing bore 7 and is retained therein. The retainment of the bearing bushings 9 is described in greater detail below with reference to the further drawing figures, which can be representative for the bearing bushings of both of the universal joints 1.

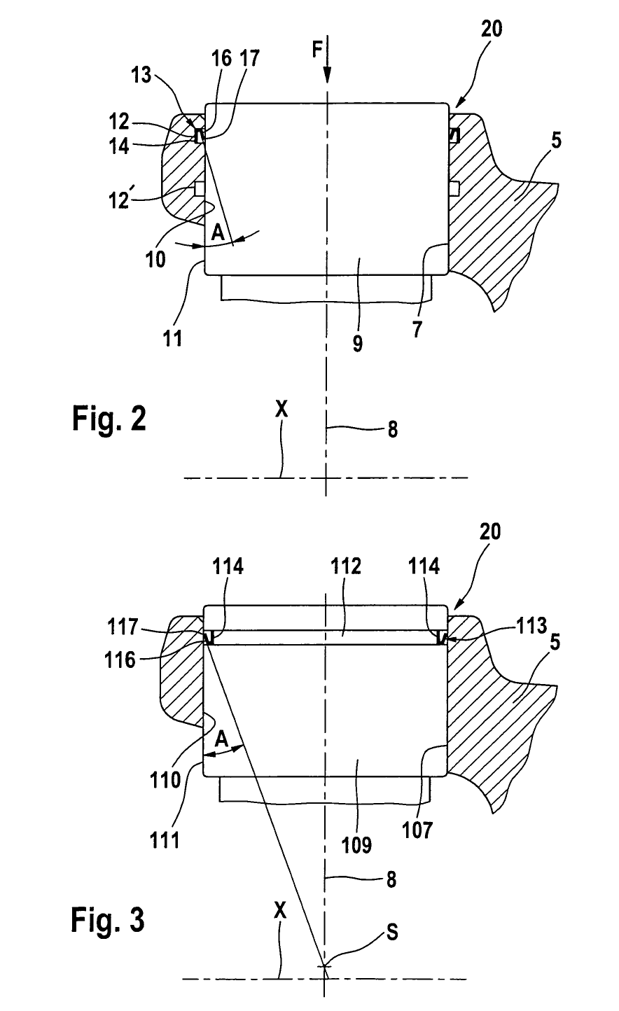

FIG. 2 illustrates a first embodiment for an axial retaining arrangement according to this invention. In this first embodiment, a portion of a yoke arm 5 of one of the joint yokes 3, 4 is shown. In the yoke arm 5, the bearing bore 7 is centered on the longitudinal axis 8 and has a bore wall 10 and extending fully through the yoke arm 5, i.e., between an inner face facing the axis of rotation X and an outer face of the yoke arm 5 facing away from the axis of rotation X. An opening of the bearing bore 7 in this area forms an insertion end, indicated generally at 20, for the bearing bushing 9. The bearing bushing 9 is, starting from this insertion end 20, inserted in the insertion direction F into the bearing bore 7. The bearing bushing 9 has an outer face 11 that contacts the bore wall 10 of the bearing bore 7.

The retainment is achieved by the following arrangement. In the bearing bore 7, an annular groove 12 is arranged toward the insertion end 20. A retaining ring, indicated generally at 13, is provided having a first ring portion 14, which is formed approximately cylindrical in shape and is retained in the annular groove 12 axially, i.e., in direction of the longitudinal axis 8 in this annular groove 12. This first ring portion 14 of the retaining ring 13 is followed preferably by several circumferentially distributed second ring portions 16 that form, at their respective free ends, an engagement edge 17 that engages the opposed outer face 1 1 of the bearing bushing 9 so as to prevent an exiting of the bearing bushing 9 under the influence of centrifugal forces or other forces against the insertion direction F.

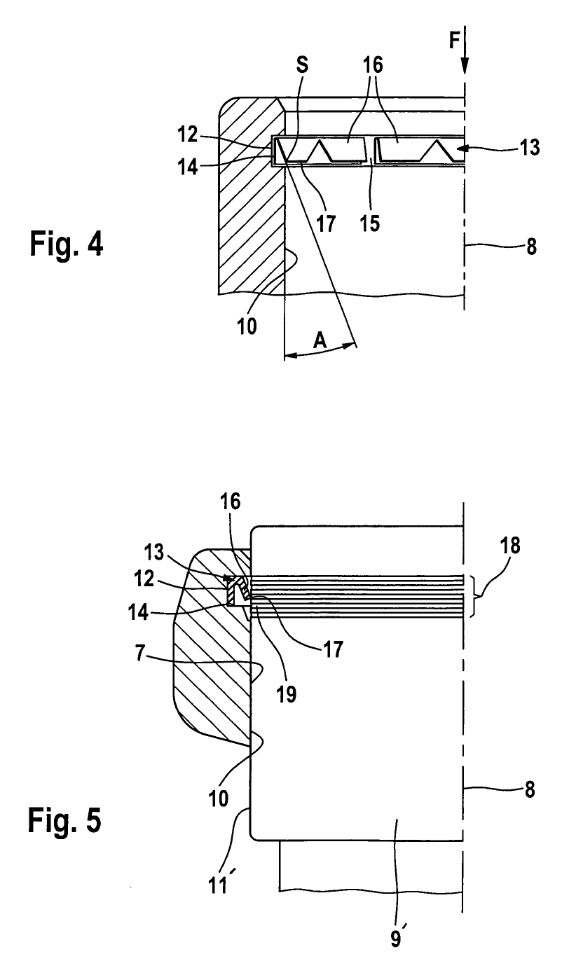

The second ring portions 16 are arranged at an angle A relative to the first ring portion 14 such that the retaining ring 13 opens up away from the insertion end 20 of the bearing bore 7. The annular groove can, if desired, be arranged along the longitudinal axis 8 at any position of the bearing bore 7. In FIG. 2, to show this, another annular groove 12′, which is displaced further away from the insertion end 20 and closer toward the axis of rotation X, is represented. The retaining ring 12 is again described in more detail in connection with FIG. 4.

In the second embodiment of this invention illustrated in FIG. 3, an annular groove 112 is not arranged in a bore wall 110 of a bearing bore 107 in the yoke arm 5, but rather is provided in an outer face 111 of a bearing bushing 109. The annular groove 112 accommodates a retaining ring, indicated generally at 113, having a first ring portion 114, resting in the annular groove 112, and second ring portions 116 that are attached offset on the circumference of the first ring portion 114 and on which free ends, respectively, an engagement edge 117 is provided. The engagement edges 117 engage a bore wall 110 of the bearing bore 107. The bearing bore 107, of itself, has no annular groove provided therein. The arrangement of the retaining ring 113 is such that the engagement edges 117 arranged on the second ring portions 116 face in a direction toward the insertion end 20 of the bearing bore 107. In this case, the second ring portions 116 are arranged in relation to the bore wall 110 at an angle A, which is preferably larger than 7° and which opens up away from the insertion end 20. The engagement edges 117 face toward the insertion end 20.

In FIG. 4, the retaining ring 13, as it is used in connection with the embodiment of FIG. 2, is shown in more detail. The first ring portion 14, extending around the longitudinal axis 8 and coming into engagement with the annular groove 12 and the second ring portions 16 attached thereto and arranged distributedly on its circumference, are visible. The second ring portions form, respectively at their free ends, the engagement edges 17. Furthermore, the V-like inclination of the second ring portions 16 relative to the bore wall 10 and, thus, the first ring portion 14 starting from the apex S under the angle A, is visible. Further, it is visible that the retaining ring 13 is axially slotted, i.e., it has a slot 15 so that it can be elastically compressed for the assembly in the annular groove 12, whereafter it, when it is arranged in the area of the annular groove 12, again takes up its original shape.

By the orientation of the second ring portions 16, it is possible to insert the bearing bushing 9 starting from the insertion end 20 into the bearing bore 7 without the engagement edges 17 of the second ring portions 16 producing an essential resistance against this inserting, as they can elastically escape into the annular groove 12 because of the elastic construction of the retaining ring 13, whereby the pressing force is produced. If, however, a force is produced against the insertion direction F of FIG. 2, the engagement edges 17 engage more strongly in the outer face 11 of the bearing bushing 9 and retain the same against radial displacement outwardly away from the axis of rotation X.

The difference between the retaining ring 13 of FIG. 4 and a modified retaining ring 113 shown in FIG. 3 is only that the second ring portions 116 are not arranged on the inside on the first ring portion 114, but at the outside of the same, i.e., in relation to the longitudinal axis 8.

Preferably, the retaining rings 13, 113 are manufactured from a metal sheet material having good elastic characteristics, wherein in a longitudinal sectional view of the ring 13, 113, the first ring portion 14, 114 and the second ring portions 16, 116 form a V-shape.

FIG. 5 shows another variant of this invention that is similar to the structure shown in FIG. 2, wherein additionally on an outer face 11′ of a modified bearing bushing 9′, one or more circumferential grooves 19 are arranged. These circumferential grooves 19 extend about the circumference of the modified bearing bushing 9′, and the engagement edges 17 of the second ring portions 16 of the retaining ring 13 engage such circumferential grooves 19. Thus, an increase of the retaining forces is achieved in the axial direction, i.e., along the longitudinal axis 8, against the insertion direction F of the bearing bushing 9. Several of such circumferential grooves 19 distributed along the longitudinal axis 8 can be provided, which together form a contact portion 18 for the retaining ring 13. Instead of the circumferential grooves 18, a knurl or a changed, i.e., rough surface, can be provided. In this case, however, it may be considered that the circumferential grooves 19 or changed surfaces do not project over the residual portion of the outer face 11 ′ of the modified bearing bushing 9′. It should be prevented that the contact portion 18 is damaged during the insertion of the bearing bushing 9′ into the bearing bore 7 and its bore wall 10.

Alternatively, for the construction or arrangement of the retaining ring and the annular groove in the bearing bushing of FIG. 3, it is possible to arrange the contact portion with circumferential grooves or a knurl or changed roughness to the surface of the bearing bore 107, i.e., their bore wall 110.

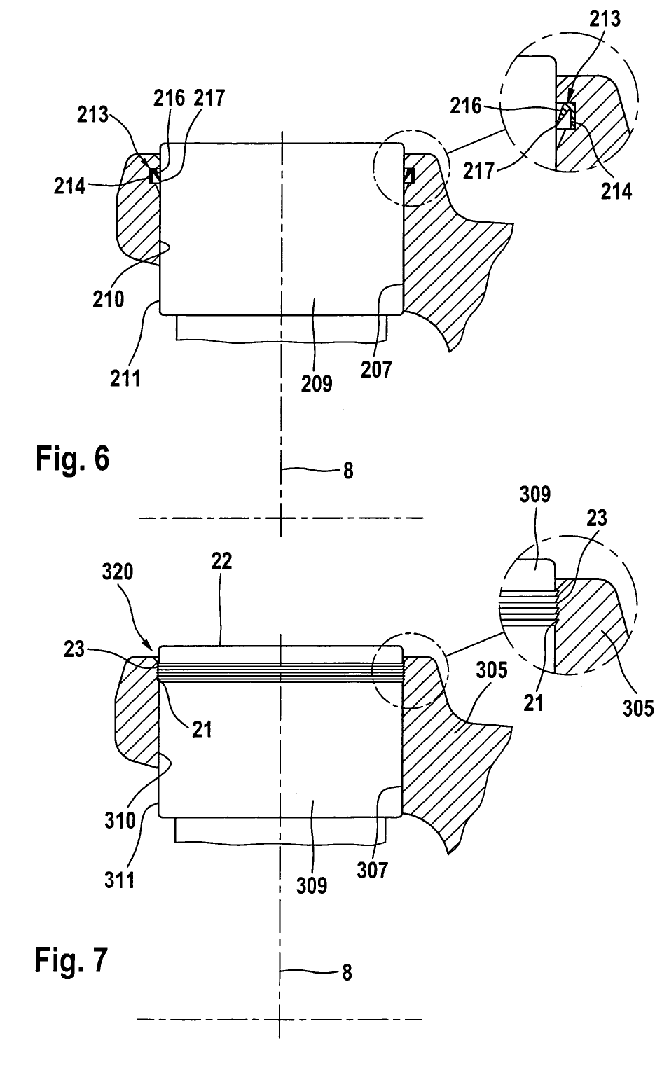

FIG. 6 shows another different embodiment for a retaining ring, indicated generally at 213. The retaining ring 213 shown here includes a first ring portion 214 that is arranged in a corresponding annular groove formed in a bearing bore 207 and, attached thereto, at least one second portion fully extending around the circumference or several individual second ring portions 216, each ending at their free ends in an acute engagement edge 217. In the embodiment shown in FIG. 6, the retaining ring 213 is also slotted so that it can be compressed for the assembly in the corresponding annular groove formed in a bore wall 210 of the bearing bore 207 or, alternatively, expanded to be disposed within an annular groove (not shown) provided in an outer face 211 of a bearing bushing 209. Also a construction is possible in which the second ring portion(s) 216 are either attached on the inner circumference of the first ring portion 214 of the retaining ring 213 (when an arrangement is carried out similar to FIG. 2) or, instead, are attached to the outer circumference of the first ring portion 214 (when an arrangement is carried out similar to FIG. 3 and the arrangement to the annular groove in the bearing bushing is desired). Concerning the further parts and arrangement, it is referred to the description of FIG. 2, while in FIG. 6 reference numerals are selected which are for parts comparable to those in FIG. 2 increased by the numerical value 200.

FIG. 7 shows a further embodiment of the invention wherein in a yoke arm 305 close to an insertion end, indicated generally at 320, of a bearing bore 307, several first sawtooth-like teeth 21, extending around the longitudinal axis 8, are provided in an outer face 311. The first sawtooth-like teeth 21 have, in the direction toward the insertion end 320, relatively steep flanks. Correspondingly, a further modified bearing bushing 309 is provided at its outer face with second teeth 23 extending around the circumference and that are arranged close to an end 22 of the bearing bushing 309. The second teeth 23 are arranged radially at the outer end and are formed complementarily to the first teeth 21, wherein the second teeth 23 project in the direction radially away from the longitudinal axis 8 to the outside beyond the residual part of the outer face 311 of the bearing bushing 309 for the engagement with the first teeth 21 in a bore wall 310 of the bearing bore 307. The first teeth 21 are arranged such, that they do not project beyond the residual part of the bore wall 310 radially inwards towards the longitudinal axis 8, to prevent damage of the outer face 311 of the bearing bushing 309.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. An axial retaining arrangement comprising:
a bearing bushing in a bearing bore forming a bore wall of a yoke arm of a joint yoke belonging to a universal joint or of a bearing element, wherein:
the bearing bushing has an outer face with which it rests in the bearing bore,
the bearing bore defines a longitudinal axis,
the bore wall of the bearing bore or the outer face of the bearing bushing has an annular groove centered on the longitudinal axis,
the retaining ring has a first ring portion retained in the annular groove, and
the retaining ring has at least one second ring portion following to the first ring portion that is elastic in the radial direction and which at least forms one engagement edge that, depending on the arrangement of the annular groove to the bearing bore or the bearing bushing, is pressing against the bore wall or the outer face, respectively.

2. An axial retaining arrangement according to claim 1, characterized in that a portion of the bore wall or the outer face forms a contact portion for the engagement edge of the retaining ring, and wherein the contact portion has a rough surface or is provided with a knurl or with circumferential grooves.

3. An axial retaining arrangement according to claim 1, characterized in that the contact portion does not project over the residual portion of the outer face of the bearing bushing or of the bore wall.

4. An axial retaining arrangement according to claim 1, characterized in that the at least one second ring portion having the engagement edge extends relative to the bore wall in the assembled condition with an angle that is larger than 70 and smaller than 90°.

5. An axial retaining arrangement according to claim 1, characterized in that the annular groove is arranged in the bore wall of the bearing bore such that the engagement edge of the retaining ring faces away from an insertion end of the bearing bore through which the bearing bushing is inserted into the bearing bore.

6. An axial retaining arrangement according to claim 1, characterized in that the annular groove is arranged in the outer face of the bearing bushing such that the engagement edge(s) of the retaining ring face an insertion end of the bearing bore through which the bearing bushing is inserted into the bearing bore.

7. An axial retaining arrangement according to claim 1, characterized in that the retaining ring is separated in the direction of the longitudinal axis at one position.

8. An axial retaining arrangement according to claim 1, characterized in that the retaining ring is formed from a metal sheet, and wherein the at least one second ring portion is bent relative to the first ring portion forming a V when seen in a longitudinal section.

9. An axial retaining arrangement according to claim 1, characterized in that the first ring portion is formed solid, to which the at least one second ring portion is unitarily connected.

10. An axial retaining arrangement comprising:
a bearing bushing with a through bearing bore forming a bore wall of a yoke arm of a joint yoke belonging to a universal joint or of a bearing element, wherein:
the bearing bushing has an outer face with which it rests in the bearing bore,
the bearing bore forms a longitudinal axis,
the bearing bore forms an insertion end for the bearing bushing,
the bore wall of the bearing bore is provided in the direction towards the insertion end over a circumference with first teeth off-set axially along the longitudinal axis, which tips do not project in direction towards the longitudinal axis over the residual face of the bore wall,
the bearing bushing has, at a rearward end when viewed in an insertion direction into the bearing bore, second teeth on the outer face interacting with the first teeth, which second teeth engage in the first teeth and project correspondingly over the outer face of the bearing bushing away from the longitudinal axis.
